(19) United States
(12) Patent Application Publication
(10) Pub. No.: US 2026/0304060 A1
(43) Pub. Date: Oct. 1, 2026

(54) SPATIAL AUDIO ADJUSTMENT BASED ON USER HEADING AND HEAD ROTATION

(71) Applicant: QUALCOMM Incorporated, San Diego, CA (US)

(72) Inventors: Graham Bradley DAVIS, Seattle, WA (US); Jason FILOS, Newark, NJ (US); Andrea Felice GENOVESE, Brooklyn, NY (US); Bala RAMASAMY, San Marcos, CA (US); Andre SCHEVCIW, San Diego, CA (US)

(21) Appl. No.: 19/477,683

(22) PCT Filed: Apr. 24, 2024
(86) PCT No.: PCT/US2024/025942

§ 371 Date: Oct. 22, 2025

(30) Foreign Application Priority Data
Jun. 22, 2023 (GR) 20230100500

(51) Int. Cl. H04S 7/00; G01P 13/00

(52) U.S. Cl. CPC H04S 7/304; G01P 13/00; H04S 2400/11

(57) ABSTRACT

A device includes one or more processors configured to determine heading information based on position data from a navigation system. The one or more processors are configured to determine head rotation data based on sensor data associated with motion of a user's head. The one or more processors are further configured to determine, based on a comparison of the heading information and the head rotation data, whether to perform a spatial audio adjustment for audio playback.

### I. CROSS-REFERENCE TO RELATED APPLICATIONS

The present application claims the benefit of priority from the commonly owned Greece Patent Application No. 20230100500, filed Jun. 22, 2023, the contents of which are expressly incorporated herein by reference in their entirety.

### II. FIELD

The present disclosure is generally related to adjusting spatial audio for playback based on user movement.

### III. DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

Some such devices are capable of performing dynamic spatial audio rendering in which a user's head orientation is tracked and used to adjust a sound field during playback of audio. For example, an inertial measurement unit (IMU) in an earphone worn by a user can provide sensor data that indicates a change of orientation of the user's head to an audio source device. The change in orientation can be used to dynamically adjust the sound field to compensate for head rotation of the user. However, a single IMU cannot distinguish between “relative” orientation changes in which the user's head orientation changes relative to the user's body, and “shared” orientation changes in which the user's head orientation and body orientation change together. For example, a user seated in the passenger seat of a turning vehicle experiences a shared orientation change (e.g., the user's head and body turn together as a result of the vehicle turning) that may cause the audio source device to improperly adjust the sound field to compensate for the detected change in the user's head orientation.

Conventionally, distinguishing between relative orientation changes and shared orientation changes is based on inertial measurement unit (IMU) data from two devices, such as a first IMU in an earphone used to play out audio and a second IMU in a mobile phone that streams the audio to the earphone. In some applications, relative orientation changes can be used to dynamically adjust the sound field, such as to compensate for head rotation detected for an otherwise stationary user, while shared orientation changes may be ignored.

Using two IMUs to distinguish between relative and shared orientation changes provides robust results when the two devices (e.g., the earphone and the mobile phone) are in a relatively static relative position, such as when the user is holding the mobile phone stationary to watch a video while listening to associated audio on the earphone. Under less favorable conditions, such as when the mobile phone is carried in the user's pocket, the IMU data can be “incoherent” in that it is difficult or impossible to reliably determine changes in orientation of the user's head relative to the user's body by analyzing the data from the two IMUs. Typically, conventional systems disable dynamic spatial rendering of the audio under such conditions.

An improved technique to more reliably track changes in orientation between the user's head and the user's body would enable dynamic spatial audio rendering to be performed even under conditions that would conventionally result in incoherent IMU data, resulting in an improved user experience.

### IV. SUMMARY

According to a particular aspect, a device includes one or more processors configured to determine heading information based on position data from a navigation system. The one or more processors are configured to determine head rotation data based on sensor data associated with motion of a user's head. The one or more processors are also configured to determine, based on a comparison of the heading information and the head rotation data, whether to perform a spatial audio adjustment for audio playback.

According to a particular aspect, a method includes determining, at a device, heading information based on position data from a navigation system. The method includes determining, at the device, head rotation data based on sensor data associated with motion of a user's head. The method also includes determining, at the device and based on a comparison of the heading information and the head rotation data, whether to perform a spatial audio adjustment for audio playback.

According to a particular aspect, a non-transitory computer-readable medium stores instructions that, when executed by one or more processors, cause the one or more processors to determine heading information based on position data from a navigation system. The instructions also cause the one or more processors to determine head rotation data based on sensor data associated with motion of a user's head. The instructions further cause the one or more processors to determine, based on a comparison of the heading information and the head rotation data, whether to perform a spatial audio adjustment for audio playback.

According to a particular aspect, an apparatus includes means for determining heading information based on position data from a navigation system. The apparatus includes means for determining head rotation data based on sensor data associated with motion of a user's head. The apparatus also includes means for determining, based on a comparison of the heading information and the head rotation data, whether to perform a spatial audio adjustment for audio playback.

Other aspects, advantages, and features of the present disclosure will become apparent after review of the entire application, including the following sections: Brief Description of the Drawings, Detailed Description, and the Claims.

### V. BRIEF DESCRIPTION OF THE DRAWINGS

FIG. 1 is a diagram that includes a system for spatial audio adjustment based on user heading and head rotation, in accordance with some examples of the present disclosure.

FIG. 2A is a diagram of an example of user movement that includes head rotation without a change in heading, in accordance with some examples of the present disclosure.

FIG. 2B is a diagram of a second example of user movement that includes relative head rotation and an incongruous change in heading, in accordance with some examples of the present disclosure.

FIG. 2C is a diagram of a third example of user movement that includes shared head rotation and a congruous change in heading, in accordance with some examples of the present disclosure.

FIG. 3 is a diagram of a device operable to perform spatial audio adjustment based on user heading and head rotation, in accordance with some examples of the present disclosure.

FIG. 4 is a diagram of a multi-device system for spatial audio adjustment based on user heading and head rotation, in accordance with some examples of the present disclosure.

FIG. 5 is a diagram that includes components that may be included in a multi-device system for spatial audio adjustment based on user heading and head rotation, in accordance with some examples of the present disclosure.

FIG. 6 is a diagram of a device operable to perform spatial audio adjustment based on user heading and head rotation, in accordance with some examples of the present disclosure.

FIG. 7 illustrates an example of an integrated circuit operable to adjust spatial audio based on user heading and head rotation, in accordance with some examples of the present disclosure.

FIG. 8 is a diagram of a headset operable to adjust spatial audio based on user heading and head rotation, in accordance with some examples of the present disclosure.

FIG. 9 is a diagram of a headset, such as a virtual reality, mixed reality, or augmented reality headset, operable to adjust spatial audio based on user heading and head rotation, in accordance with some examples of the present disclosure.

FIG. 10 is a diagram of earbuds operable to adjust spatial audio based on user heading and head rotation, in accordance with some examples of the present disclosure.

FIG. 11 is a diagram of a system including a mobile device operable to adjust spatial audio based on user heading and head rotation, in accordance with some examples of the present disclosure.

FIG. 12 is a diagram of a system including a wearable electronic device operable to adjust spatial audio based on user heading and head rotation, in accordance with some examples of the present disclosure.

FIG. 13 is a diagram of a vehicle operable to adjust spatial audio based on user heading and head rotation, in accordance with some examples of the present disclosure.

FIG. 14 is a diagram of a particular implementation of a method of spatial audio adjustment based on user heading and head rotation that may be performed by the device of FIG. 1, in accordance with some examples of the present disclosure.

FIG. 15 is a block diagram of a particular illustrative example of a device that is operable to adjust spatial audio based on user heading and head rotation, in accordance with some examples of the present disclosure.

### VI. DETAILED DESCRIPTION

Systems and methods of spatial audio adjustment based on user heading and head rotation are described. Conventional systems that perform dynamic spatial audio rendering based on detecting head movement using a single device, such as an IMU in a headset, are unable to distinguish between “relative” orientation changes in which the user's head orientation changes relative to the user's body, and “shared” orientation changes in which the user's head orientation and body orientation change together. Systems that use IMU data from two devices, such as a headset and a mobile phone, can often distinguish between relative orientation changes and shared orientation changes. However, under certain conditions, such as when one of the devices is in the user's pocket, the IMU data from the two devices becomes incoherent, making it difficult or impossible to reliably determine changes in orientation of the user's head relative to the user's body.

The disclosed systems and methods include the use of heading information and user head rotation data to distinguish between relative orientation changes and shared orientation changes. According to an aspect, the heading information is determined using a satellite-based positioning system, such as a global network satellite system (GNSS) (e.g., global positioning system (GPS), Galileo, etc.), and indicates a direction of user movement based on changes in the user's position. Changes in the user's heading typically correspond to changes in the user's body orientation when the user is walking, traveling in a vehicle, etc.

In some implementations, a change in the user's head orientation is determined from IMU data and compared to a change in the user's heading. According to some examples, a change in the user's head orientation that does not match a change in the user's heading indicates a relative orientation change and the sound field is dynamically adjusted to compensate for the relative head rotation of the user, while a change in the user's head orientation that matches the change in the user's heading indicates a shared orientation change and the sound field is not adjusted.

In some implementations, an IMU and a satellite positioning system receiver are integrated in a single head-mounted device, such as an audio headset or extended reality (XR) headset, enabling the head-mounted device to differentiate between changes in head orientation alone (due to head rotation) and shared changes in head and body orientation (due to changes in heading). In other implementations, an IMU and a satellite positioning system receiver are integrated in separate devices of a multi-device system (e.g., earphones paired with a mobile phone) to differentiate between changes in head orientation alone and shared changes in head and body orientation.

The use of heading information to detect changes in body orientation enables the present systems and methods to more reliably track changes in orientation between the user's head and the user's body and enable dynamic spatial audio rendering to be performed even under conditions that would conventionally result in incoherent IMU data, resulting in an improved user experience. In addition, using heading information in conjunction with head rotation data enables accurate dynamic spatial audio rendering to be provided using a single device that differentiates between relative and shared orientation changes, thus reducing cost, complexity, and sound field adjustment delay associated with wireless transmission of IMU data between devices, as compared to conventional systems that collect and process IMU data from multiple devices.

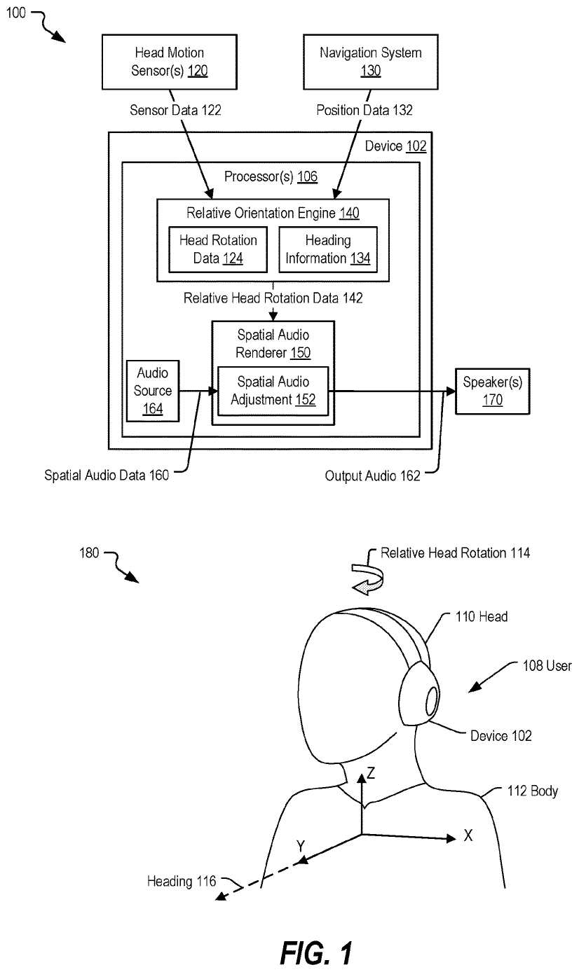

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 1 depicts a device 102 including one or more processors (“processor(s)” 106 of FIG. 1), which indicates that in some implementations the device 102 includes a single processor 106 and in other implementations the device 102 includes multiple processors 106. For ease of reference herein, such features are generally introduced as “one or more” features and are subsequently referred to in the singular or optional plural (as indicated by “(s)” in the name of the feature) unless aspects related to multiple of the features are being described.

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

Referring to FIG. 1, a particular illustrative aspect of a system 100 for spatial audio adjustment based on user heading and head rotation is shown. In the example illustrated in FIG. 1, the system 100 includes a device 102 coupled to one or more head motion sensors 120, a navigation system 130, and one or more speakers 170. The device 102 is configured to process sensor data 122 from the head motion sensor 120 and position data 132 from the navigation system 130 to determine a motion of a user's head 110 relative to the user's body 112. The relative motion of the user's head 110 is used to selectively adjust spatial audio prior to playout at the speakers 170.

A diagram 180 illustrates an example of a user 108 wearing the device 102 as a head-mounted device. As illustrated, the user 108 may rotate the user's head 110 left or right relative to the user's body 112, resulting in a relative head rotation 114. The motion of the user's head 110 can be detected by the head motion sensor 120, such as an IMU that is included in the device 102. For example, the head motion sensor 120 can include one or more accelerometers, gyroscopes, or other sensors configured to detect a change of position of the user's head 110.

In addition, a heading 116 of the user 108 can be determined using the position data 132 from the navigation system 130. For example, the navigation system 130 can correspond to a satellite-based navigation system, such as a GNSS receiver configured to determine positioning information (e.g., latitude and longitude coordinates) that is provided to the device 102 via the position data 132. A translational motion of the user 108 (e.g., motion of the user's body 112 while walking, running, or riding in a vehicle) can be determined by detecting a change of position of the navigation system 130 over time to determine the heading 116 associated with the translational motion.

According to an aspect, the heading 116 is determined based on changes in position and is not affected by changes in orientation (e.g., the heading 116 does not change solely based on rotation of the user's head 110, rotation the user's body 112, or both). For example, the diagram 180 depicts the user 108 centered on a coordinate axis having an X axis in the direction of side-to-side motion of the user 108, a Y axis in the direction of forward and backward motion of the user 108, and a Z axis in the direction of up and down motion of the user 108. The navigation system 130 is operative to detect changes in the location of the user 108 along the X and Y axes, which are used to determine the heading 116. In some implementations, the navigation system 130 is further operative to detect changes in the location of the user 108 along the Z axis, which is also used to determine the heading 116. In the example illustrated in the diagram 180, the heading 116 is represented as a vector along the direction of the Y axis, indicating a forward motion of the user 108.

The device 102 includes one or more processors 106 that are configured to receive and process the sensor data 122 and the position data 132. The processor 106 includes a digital signal processor (DSP), one or more other types of processor, or a combination thereof. The processor 106 includes a relative orientation engine 140 and a spatial audio renderer 150. Functionality associated with the relative orientation engine 140, the spatial audio renderer 150, or both, may be implemented via dedicated hardware, implemented via execution of computer instructions at the processor 106, or a combination thereof.

The relative orientation engine 140 is configured to determine head rotation data 124 based on the sensor data 122 associated with motion of the user's head 110. For example, the sensor data 122 can include data indicative of sequential measurements of rotational orientation of the user's head 110, angular velocity associated with changes in the rotational orientation of the user's head 110, angular acceleration associated with changes in the angular velocity, or a combination thereof. The relative orientation engine 140 can process (e.g., filter, integrate, etc.) the sensor data 122 to generate the head rotation data 124 that tracks the orientation of the user's head 110, tracks changes in the orientation of the user's head 110, or both.

The relative orientation engine 140 is also configured to determine heading information 134 based on the position data 132 from the navigation system 130. For example, the heading information 134 can include data indicative of sequential location measurements of the user's head 110, changes between sequential location measurements of the user's head 110, or a combination thereof. The relative orientation engine 140 can process (e.g., filter, integrate, etc.) the position data 132 to generate the heading information 134 that tracks the heading 116, tracks changes in the heading 116, or both.

The relative orientation engine 140 is configured to generate relative head rotation data 142 based on the head rotation data 124 and the heading information 134. For example, in some implementations, the relative orientation engine 140 is configured to subtract a change in the user's heading 116 indicated by the heading information 134 from a change in the user's head orientation indicated by the head rotation data 124 to determine a change in the relative head rotation 114. In this example, the relative head rotation data 142 can indicate a change in orientation of the user's head 110 relative to a change in the direction of motion of the user 108.

According to an aspect, the relative orientation engine 140 is configured to distinguish between rotation of the user's head 110 relative to the user's body 112, and rotation of the user's head 110 and body 112 together. For example, when the head rotation data 124 indicates a change in orientation of the user's head 110 that matches the change in heading 116 indicated by the heading information 134, the relative orientation engine 140 may generate the relative head rotation data 142 indicating that the user's head 110 has not rotated relative to the user's body 112. Alternatively, when the head rotation data 124 indicates a change in orientation of the user's head 110 that does not match the change in heading 116 indicated by the heading information 134, the relative orientation engine 140 may generate the relative head rotation data 142 indicating that the user's head 110 has rotated relative to the user's body 112. According to an aspect, the relative orientation engine 140 may determine that the change in orientation of the user's head 110 matches the change in heading 116 when a magnitude of a difference between the change in heading 116 and the change in orientation of the user's head 110 is less than a threshold. The relative orientation engine 140 may determine that the change in orientation of the user's head 110 does not match the change in heading 116 when the magnitude of the difference between the change in heading 116 and the change in orientation of the user's head 110 exceeds the threshold.

The spatial audio renderer 150 is configured to receive spatial audio data 160 from an audio source 164, such as a multimedia file, a streaming audio source (e.g., video conference application), a game engine, etc. The spatial audio renderer 150 is configured to process the spatial audio data 160 to generate output audio 162 that is provided to the speakers 170 for playout. In an example, the spatial audio data 160 has a channel-based audio format, such as a 5.1 audio channel format or a 7.1 audio channel format corresponding to specific speaker geometries, an object-based audio format, such as discrete pulse-code-modulation (PCM) data for single audio objects with associated metadata containing their location coordinates (amongst other information), scene-based audio, which involves representing the sound field using coefficients of spherical harmonic basis functions (also called “spherical harmonic coefficients” or SHC, “Higher-order Ambisonics” or HOA, “HOA coefficients,” etc.), or any combination thereof. The spatial audio renderer 150 is configured to render the spatial audio data 160, such as by performing one or more operations such as mixing, translating, rotating, and binauralizing the resulting audio to generate the output audio 162.

The spatial audio renderer 150 is configured to perform a spatial audio adjustment 152 based on the relative head rotation data 142. The spatial audio adjustment 152 includes performance of one or more rotation operations associated with the spatial audio data 160 to compensate for the relative head rotation 114. According to an aspect, when the relative head rotation data 142 indicates that a change in orientation of the user's head 110 does not match a change in the heading 116, the spatial audio renderer 150 performs the spatial audio adjustment 152 to emulate the effect of the user's head 110 rotating relative to one or more sound-emitting sources in a virtual audio environment. According to some aspects, the head rotation data 142 includes information (e.g., an angle of rotation) indicating an amount of the relative head rotation 114 to be used to render the spatial audio data 160.

During operation in accordance with a particular implementation, the head motion sensor 120 tracks the head rotation of the user 108 and the navigation system 130 tracks the position of the user 108 while the user 108 uses the device 102 for audio playback. To illustrate, the device 102 may be worn on the user's head 110 and the head motion sensor 120 and the navigation system 130 may be integrated in the device 102. In an example, the device 102 corresponds to a headset (e.g., a pair of earbuds or other earphones) that includes the head motion sensors 120 and the navigation system 130 and that also includes the speakers 170. As such, the device 102 provides improvement over systems that require two devices—one on a user's head and one on the user's body—to determine a relative head motion of the user.

During playback of the spatial audio data 160, the processor 106 receives the sensor data 122 and the position data 132 and generates the head rotation data 124 and the heading information 134 at the relative orientation engine 140. The processor 106 determines, based on a comparison of the heading information 134 and the head rotation data 124, whether to perform the spatial audio adjustment 152 of the audio. For example, the comparison can include determining a change in relative orientation of the user's head 110 as compared to the user's body 112. The comparison may be performed by the relative orientation engine 140 to distinguish between rotation of the user's head 110 relative to the user's body 112, and rotation of the user's head 110 and body 112 together, based on whether a detected rotation of the user's head 110 matches a detected change in the heading 116.

According to some aspects, in response to detecting the rotation of the user's head 110 relative to the user's body 112, such as when the user's head 110 turns while the user 108 is stationary or while the user 108 is moving in a straight line with no change of heading 116, the processor 106 performs the spatial audio adjustment 152. For example, the relative orientation engine 140 provides the relative head rotation data 142 indicating the relative head rotation 114 to the spatial audio renderer 150, which performs one or more rotation operations associated with the spatial audio adjustment 152 to generate the output audio 162 that compensates for the relative head rotation 114.

Otherwise, in response to detecting the rotation of the user's head 110 and body 112 together, the processor 106 refrains from performing the spatial audio adjustment 152. To illustrate, the spatial audio adjustment 152 may not be performed in response to detecting the user's head 110 has not rotated relative to the user's body 112, such as when the user's head 110 is stationary while the user 108 is stationary or moving in a straight line with no change of heading 116, or when the rotation of the user's head 110 matches the change in the heading 116, as illustrative, non-limiting examples.

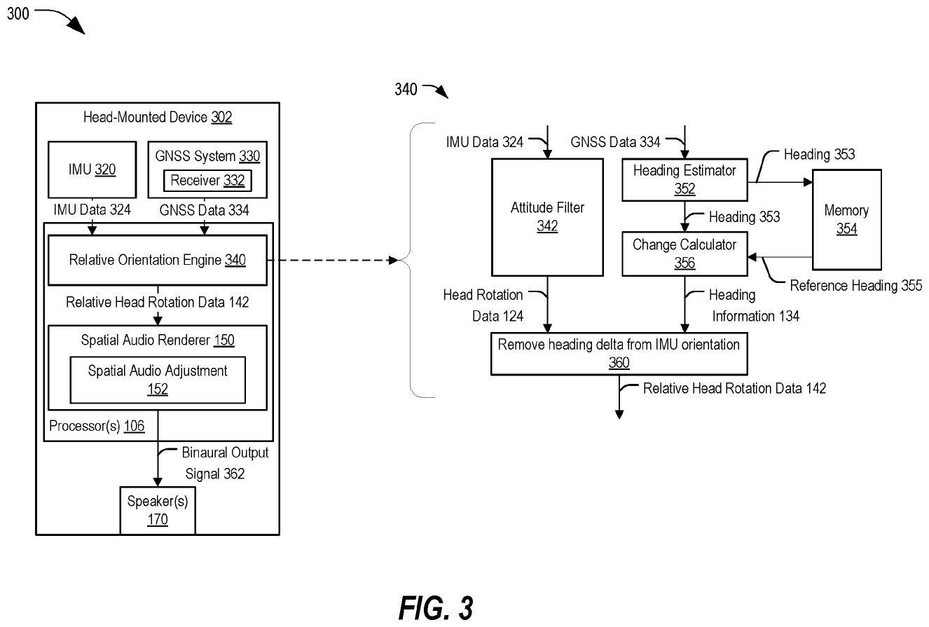

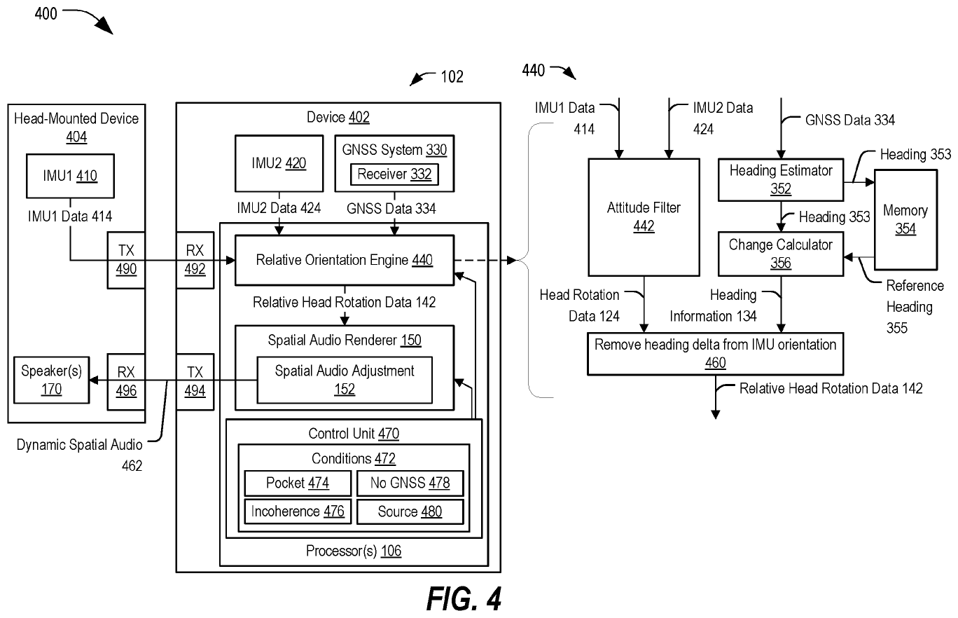

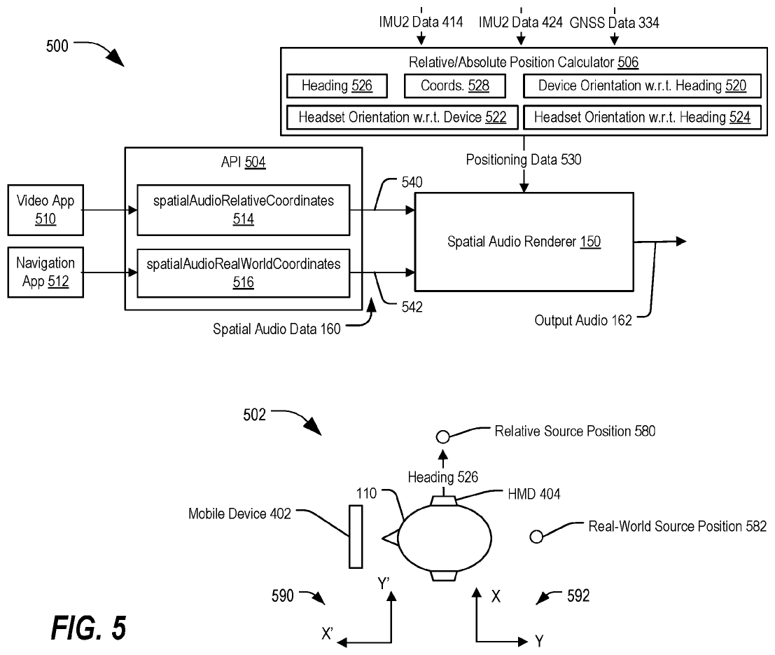

Although the above description provides an example of operation in which the one or more processors 106, the head motion sensor 120, and the navigation system 130 are integrated in a head-mounted device, in other examples a multi-device configuration can instead be used in which the processor 106 and the navigation system 130 are integrated in a first device (e.g., a mobile phone) while the head motion sensor 120 is integrated in a second device (e.g., a headset) that is communicatively coupled to the first device. An example of a head-mounted configuration is described in further detail with reference to FIG. 3, and examples of a multi-device configuration are described in further detail with reference to FIG. 4 and FIG. 5.

By using the heading information 134 to detect changes associated with orientation of the user's body 112 in conjunction with the head rotation data 124 to detect changes associated with orientation of the user's head 110, the device 102 can more reliably track changes in orientation between the user's head 110 and the user's body 112 and enable dynamic spatial audio rendering to be performed even under conditions that would conventionally result in incoherent IMU data, resulting in an improved user experience.

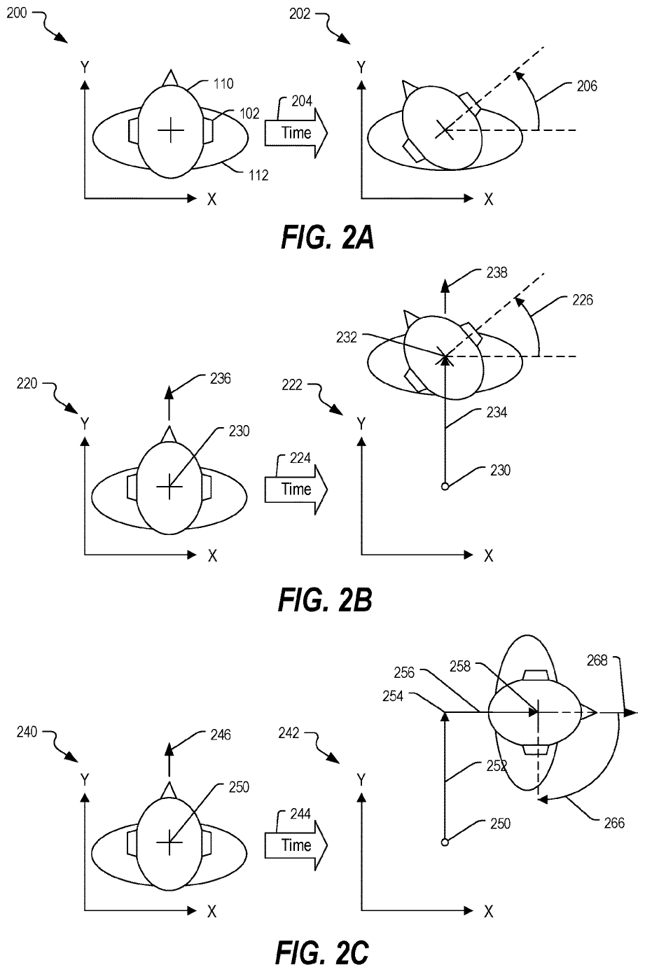

FIGS. 2A, 2B, and 2C depict examples of various combinations of head rotations and headings that may be exhibited by the user 108 of the device 102. In each of FIGS. 2A, 2B, and 2C, a pair of top view diagrams depict the device 102 as a pair of earphones worn by the user 108 and show a starting position and head orientation of the user 108 and a later position and head orientation of the user 108 after an elapse of time.

FIG. 2A depicts an example in which the user's head 110 rotates while the user's body 112 is stationary. In FIG. 2A, a first diagram 200 illustrates a starting position of the user 108 relative to an X-Y coordinate axis. The X-Y coordinate axis represent a general spatial reference frame that is independent of the user's body position. In the first diagram 200, the user's head 110 is oriented toward the positive Y direction, and the user 108 is stationary. Because the user 108 is stationary, there is no heading 116 associated with movement of the user 108 (e.g., the heading 116 may be set to a value indicating “no movement”).

A second diagram 202 illustrates a later position and head orientation of the user 108 after an elapse of time 204. In the second diagram 202, the position of the user 108 (e.g., the location of the reference “+” sign centered on the user's head 110) has not changed relative to the X-Y coordinate axis. Because there is no change in the position of the user 108, the heading 116 is unchanged (e.g., a value indicating “no movement”). The orientation of the user's head 110 has changed relative to the first diagram 200, illustrated as a rotation of the user's head 110 toward the user's left by a rotation amount corresponding to an angle 206.

When the user's head 110 rotates while the user's body 112 is stationary, as depicted in FIG. 2A, the head rotation data 124 indicates that the user's head 110 has rotated (e.g., by the angle 206), the heading information 134 indicates no change of heading, and the one or more processors 106 perform the spatial audio adjustment 152 to compensate for the head rotation of the user 108.

FIG. 2B depicts an example in which the user's head 110 rotates while the user walks in a straight line. In FIG. 2B, a first diagram 220 illustrates a starting position 230 of the user 108 relative to the X-Y coordinate axis. An arrow 236 indicates the direction that the user 108 is walking in the positive Y direction, corresponding to the heading 116 of the user 108 in the first diagram 220.

A second diagram 222 illustrates a later position and head orientation of the user 108 after an elapse of time 224. In the second diagram 222, the position of the user 108 (e.g., the location of the reference “+” sign centered on the user's head 110) has moved along a straight path 234 from the starting position 230 to an ending position 232, and an arrow 238 indicates that the user 108 continues to walk in the positive Y direction. Thus, the heading 116 of the user 108 is in the positive Y direction and unchanged from the first diagram 220. The orientation of the user's head 110 has changed relative to the first diagram 220, illustrated as a rotation of the user's head 110 toward the user's left by a rotation amount corresponding to an angle 226.

When the user's head 110 rotates while the user walks in a straight line, the head rotation data 124 indicates that the user's head 110 has rotated (e.g., by the angle 226), the heading information 134 indicates no change of heading, and the one or more processors 106 perform the spatial audio adjustment 152 to compensate for the head rotation of the user 108.

FIG. 2C depicts an example in which the user 108 walks around a corner without the user's head 110 rotating relative to the user's body 112. In FIG. 2C, a first diagram 240 illustrates a starting position 250 of the user 108 relative to the X-Y coordinate axis. An arrow 246 indicates the direction that the user 108 is walking in the positive Y direction, corresponding to the heading 116 of the user 108 in the first diagram 240.

A second diagram 242 illustrates a later position and head orientation of the user 108 after an elapse of time 244. In the second diagram 242, the position of the user 108 (e.g., the location of the reference “+” sign centered on the user's head 110) has moved along a first straight path 252 in the positive Y direction from the starting position 250 to an intermediate position 254, made a right-hand turn around the corner, and walked along a second straight path 256 in the positive X direction to an ending position 258 during the elapse of time 244. An arrow 268 indicates the direction that the user 108 is walking in the positive X direction at the conclusion of the elapse of time 244. Thus, the heading 116 of the user 108 has rotated 90 degrees in a clockward direction from the positive Y direction to the positive X direction. The orientation of the user's head 110 has also changed from its initial orientation in the first diagram 240 by 90 degrees in a clockward direction, corresponding to an angle 266.

When the user 108 walks around the corner without the user's head 110 rotating relative to the user's body 112, the head rotation data 124 indicates that the user's head 110 has rotated 90 degrees clockwise, and the heading information 134 indicates a change of heading of 90 degrees clockwise, matching the rotation of the user's head 110. Because the change in the heading 116 matches the change in the orientation of the user's head 110, the user's head 110 has not changed orientation relative to the user's body 112, and the one or more processors 106 do not perform the spatial audio adjustment 152 to compensate for the head rotation of the user 108.

FIG. 3 depicts an implementation 300 of the device 102 configured as a head-mounted device 302. An IMU 320, a GNSS system 330, and the processor 106 are integrated in the head-mounted device 302. The GNSS system 330 is a satellite-based navigation system that includes a navigation receiver 332 and that generates GNSS data 334. In a particular implementation, the IMU 320 corresponds to the head motion sensor 120, the IMU data 324 corresponds to the sensor data 122, the GNSS system 330 corresponds to the navigation system 130, and the GNSS data 334 corresponds to the position data 132.

The processor 106 includes a relative orientation engine 340 and the spatial audio renderer 150. The relative orientation engine 340 is configured to receive the IMU data 324 from the IMU 320 and the GNSS data 334 from the GNSS system 330 and to process the IMU data 324 and the GNSS data 334 to generate the relative head rotation data 142. In a particular implementation, the relative orientation engine 340 corresponds to the relative orientation engine 140 of FIG. 1.

The relative orientation engine 340 includes an attitude filter 342, a heading estimator 352, a memory 354, and a change calculator 356. The relative orientation engine 340 is configured to process the IMU data 324 using the attitude filter 342 to generate the head rotation data 124 indicating a head orientation change. For example, the attitude filter 342 can include a Kalman filter configured to process the sequence of samples in the IMU data 324 to generate an estimate of the head orientation or an estimate of a change in the head orientation.

The relative orientation engine 340 is also configured to process the GNSS data 334 using the heading estimator 352 to determine a heading estimation 353. For example, the heading estimator 352 can include a subtractor to subtract a previously received sample of the GNSS data 334 indicating a prior position of the head-mounted device 302 from a most recently received sample of the GNSS data 334 to generate the heading estimation 353. In another example, the heading estimator 352 can include one or more filters, such as a Kalman filter, configured to process the sequence of samples in the GNSS data 334 to generate the heading estimation 353. The heading estimation 353 is provided to the change calculator 356 and is also sent to the memory 354 for later retrieval.

The change calculator 356 is configured to compare the heading estimation 353 to a reference heading 355 to generate the heading information 134 indicating a heading change. The reference heading 355 corresponds to a previous heading estimation 353 that was saved to the memory 354. In an illustrative example, the change calculator 356 is configured to subtract the reference heading 355 from the heading estimation 353 to determine a change (or “delta”) in the heading 116 over a particular time period. In some implementations, the particular time period can correspond to a sample rate of the GNSS data 334 (e.g., so that the heading information 134 is updated to indicate the change between each successive sample of the GNSS data 334), a sample rate of the IMU data 324 (e.g., so that updates to the heading information 134 correspond to the same time interval as updates to the head rotation data 124), or another time period.

The relative orientation engine 340 is configured to perform an operation 360 to remove the change in the heading 116 (“heading delta”) from the change in head orientation that is based on the IMU data 324. In an example, the relative orientation engine 340 subtracts the heading information 134 from the head rotation data 124 to determine an amount of rotation of the user's head 110 relative to the user's body 112, which is included in the relative head rotation data 142. To illustrate, the head rotation data 124 can include a first angle representing a detected amount of head rotation (e.g., a change of head orientation) over a time period, the heading information 134 can include a second angle representing a change in heading over the time period, and the operation 360 can include subtracting the second angle from the first angle to generate the relative head rotation data 142.

The processor 106 is further configured to perform the spatial audio adjustment 152 at the spatial audio renderer 150 based on the relative head rotation data 142, such as described with regard to FIG. 1. For example, when the relative head rotation data 142 indicates a rotation of the user's head 110 that does not match a change in the heading 116, the spatial audio adjustment 152 can be performed to compensate the rotation of the user's head 110 relative to the change in heading 116. When the relative head rotation data 142 indicates that the rotation of the user's head 110 matches a change in the heading 116, the spatial audio adjustment 152 can be bypassed.

The spatial audio renderer 150 is configured to perform a binauralization operation in conjunction with processing spatial audio data to generate a binaural output signal 362. In a particular implementation, the binaural output signal 362 corresponds to the output audio 162 of FIG. 1. The binaural output signal 362 is provided to a pair of the speakers 170, such as a pair of earbuds or earphones included in (or coupled to) the head-mounted device 302.

By including the GNSS system 330 to determine the heading information 134 and also including the IMU 320 to determine the head rotation data 124, the head-mounted device 302 provides accurate dynamic spatial audio rendering in a single-device implementation that differentiates between relative and shared orientation changes, thus reducing cost, complexity, and sound field adjustment delay as compared to conventional systems that collect and process data from IMUs of different devices.

FIG. 4 depicts an implementation 400 of a multi-device system that includes a head-mounted device 404 coupled to another device 402, such as a mobile phone or other electronic device that is held or carried by the user 108 or worn on a portion of the user's body 112 other than on the user's head 110. In a particular implementation, the device 402 corresponds to the device 102 of FIG. 1.

The head-mounted device 404 includes a first IMU 410 (“IMU1”), a transmitter 490, a receiver 496, and the speakers 170. The first IMU 410 is configured to generate first IMU data 414 (“IMU1 data”) indicative of motion of the user's head 110. The transmitter 490 is configured to send the first IMU data 414 to the device 402, and the receiver 496 is configured to receive data, including dynamic spatial audio 462, from the device 402. For example, the transmitter 490, the receiver 496, or both, may be communicatively coupled to the device 402 via one or more wired connections, one or more wireless links, or a combination thereof. In some implementations, the transmitter 490 and the receiver 496 are included in a wireless transceiver and may be configured to communicate with the device 402 via a BLUETOOTH or WI-FI type communication network (BLUETOOTH is a registered trademark of Bluetooth SIG, Inc., WI-FI is a registered trademark of the Wi-Fi Alliance Corp.). The head-mounted device 404 is configured to provide the dynamic spatial audio 462 for playout at the speakers 170.

The device 402 includes a second IMU 420 (“IMU2”) configured to generate second IMU data 424 (“IMU2 data”) indicating motion of the device 402, the GNSS system 330 configured to generate the GNSS data 334 (e.g., position data) indicating a position of the device 402, and the processor 106. The processor 106 is configured to determine a relative orientation of the head-mounted device 404, in relation to an orientation of the device 402, using one or more combinations of the first IMU data 414, the second IMU data 424, and the GNSS data 334, as described in further detail below.

The device 402 also includes a receiver 492 configured to receive the first IMU data 414 from the first IMU 410 of the head-mounted device 404 and a transmitter 494 configured to send the dynamic spatial audio 462 to the head-mounted device 404. In some implementations, the transmitter 494 and the receiver 492 are included in a wireless transceiver and may be configured to communicate with the device 402 via a wireless communication link as described above.

The processor 106 includes a relative orientation engine 440, the spatial audio renderer 150 of FIG. 1, and an optional control unit 470. The relative orientation engine 440 is configured to receive and process the first IMU data 414, the second IMU data 424. and the GNSS data 334 to generate the relative head rotation data 142. In a particular implementation, the relative orientation engine 440 corresponds to the relative orientation engine 140 of FIG. 1. According to some aspects, the first IMU data 414 indicating motion of the head-mounted device 404 and the second IMU data 424 indicating motion of the device 402 are included in the sensor data 122 of FIG. 1, and the GNSS system 330 corresponds to the navigation system 130.

The relative orientation engine 440 includes an attitude filter 442 and also includes the heading estimator 352, the memory 354, and the change calculator 356 of FIG. 3. The attitude filter 442 is configured to process the first IMU data 414, the second IMU data 424, or both, to generate the head rotation data 124. For example, the attitude filter 442 can include one or more Kalman filters configured to process the first IMU data 414, the second IMU data 424, or both, to generate an estimate of the head rotation data 124. The heading estimator 352, the memory 354, and the change calculator 356 operate to generate the heading information 134 based on the GNSS data 334 in a similar manner as described with reference to FIG. 3. The relative orientation engine 440 is also configured to perform an operation 460 to remove the change in the heading 116 from the change in head orientation indicated by the head rotation data 124 to determine the relative head rotation data 142 in a similar manner as described with reference to the operation 360 of FIG. 3.

The spatial audio renderer 150 is configured to perform the spatial audio adjustment 152 based on the relative head rotation data 142, such as described with regard to FIG. 1 and FIG. 3, during generation of the dynamic spatial audio 462. In an example, the dynamic spatial audio 462 corresponds to a binaural output generated by the spatial audio renderer 150.

In implementations in which the device 402 includes the control unit 470, the control unit 470 is configured to send one or more control signals to the relative orientation engine 440, to the spatial audio renderer 150, or both, to adjust operation based on detection of one or more of conditions 472. For example, the control unit 470 may be configured to cause the one or more processors 106 to adjust processing of the first IMU data 414, the second IMU data 424, the GNSS data 334, or a combination thereof, based on the one or more detected conditions 472. The conditions 472 can include a pocket condition 474, an IMU incoherence condition 476, a GNSS unavailable condition 478, a source condition 480, or a combination thereof.

In some implementations, the pocket condition 474 indicates that the device 402 is detected to be in a user's pocket, handbag, backpack, etc., that reduces the usefulness of the second IMU data 424 in detecting rotation of the user's body, increases the likelihood of incoherent IMU data, or both. The pocket condition 474 can be detected via one or more visual cues (e.g., light detectors, cameras), audio cues (e.g., muffled microphone input), and/or motion cues (e.g., the second IMU data 424 exhibits one or more characteristics associated with being carried in a user's pocket). Based on detecting the pocket condition 474, the control unit 470 may send a control signal to the relative orientation engine 440 that causes the attitude filter 442 to generate the head rotation data 124 based on the first IMU data 414 and without using the second IMU data 424. Thus, the control unit 470 can cause the one or more processors 106 to determine the relative orientation of the head-mounted device 404 based on the first IMU data 414 and the GNSS data 334 when the device 402 is detected to be in a pocket.

In some implementations, the IMU incoherence condition 476 indicates that the first IMU data 414 is detected to be incoherent with the second IMU data 424. For example, the processor 106 can monitor the first IMU data 414 and the second IMU data 424, the output of the attitude filter 442, or both, to detect when the first IMU data 414 is incoherent with the second IMU data 424. Based on detecting the IMU incoherence condition 476, the control unit 470 may send a control signal to the relative orientation engine 440 that causes the attitude filter 442 to generate the head rotation data 124 based on the first IMU data 414 and without using the second IMU data 424. Thus, the control unit 470 can cause the one or more processors 106 to determine the relative orientation of the head-mounted device 404 based on the first IMU data 414 and the GNSS data 334 when the second IMU data 424 is detected to be incoherent with respect to the first IMU data 414.

In some implementations, the GNSS unavailable condition 478 indicates that the GNSS data 334 is unavailable or unreliable, such as when the device 402 is in a location where GNSS satellite signals are blocked, attenuated, intermittent, subject to interference, etc. For example, the processor 106 can determine the GNSS unavailable condition 478 based on one or more indicators from the GNSS system 330, based on analyzing the GNSS data 334, or both. Based on detecting the GNSS unavailable condition 478, the control unit 470 may send a control signal to the relative orientation engine 440 to determine the relative head rotation data 142 using the first IMU data 414 and the second IMU data 424 and without using the GNSS data 334. For example, the control signal can cause the attitude filter 442 to subtract a second rotation indicated by the second IMU data 424 from a first rotation indicated by the first IMU data 414, and to output the difference as the head rotation data 124. The head rotation data 124 may be output as the relative head rotation data 142 without using (and optionally, without generating) the heading information 134. Thus, the control unit 470 can cause the one or more processors 106 to determine the relative orientation of the head-mounted device 404 based on the first IMU data 414 and the second IMU data 424 upon detection that the GNSS data 334 is unavailable.

In some implementations, the source condition 480 indicates one or more characteristics associated with a source of the spatial audio data that affects operation of the spatial audio renderer 150. For example, when the source condition 480 corresponds to a multimedia source of the spatial audio data and associated video data, the control unit 470 may send a control signal to the spatial audio renderer 150 to dynamically adjust the sound field based on relative head rotations indicated in the relative head rotation data 142. To illustrate, the spatial audio may be in a format where the center channel is oriented in the direction of the video display, e.g., a display screen on the device 402. Rotation of the user's head 110 relative to the device 402 is compensated in the spatial audio renderer 150 via the spatial audio adjustment 152 during generation of the dynamic spatial audio 462.

As another example, when the source condition 480 corresponds to an audio source without corresponding video data, such as an audio file or streaming audio playback at a music player that is executing at the processor 106, the control unit 470 may send a control signal to the spatial audio renderer 150 to render the audio as head-locked audio, such as by disabling dynamic spatial adjustment based on the relative head rotation data 142. To illustrate, for audio-only playback (e.g., listening to music while walking), the user is likely to prefer that the sound field remain stationary relative to the user's reference frame, so that when the user turns to the right, an audio source perceived to be in front of the user remains in front of the user instead of rotating to the user's left. Rotation of the user's head 110 relative to the device 402 is therefore not compensated in the spatial audio renderer 150 (e.g., the spatial audio adjustment 152 is bypassed or disabled) during generation of the dynamic spatial audio 462.

As another example, when the source condition 480 corresponds to an audio source associated with a global coordinate system, such as a navigation application that is executing at the processor 106, the control unit 470 may send a control signal to the relative orientation engine 440 and to the spatial audio renderer 150 to render the audio as head-tracked audio based on absolute head rotation rather than based on head rotation relative to the user's body. To illustrate, for a navigation application that provides audio cues to the user indicating the real-world direction of an object (e.g., a destination address), when the user's head turns toward the object, the sound field should rotate so that the audio cues are perceived to the front of the user independently of the user's body orientation. Thus, the control unit 470 may send a control signal to the relative orientation engine 440 to determine the head rotation data 124 using the first IMU data 414 and without using the second IMU data 424, and the head rotation data 124 may be output to the spatial audio renderer 150 without using (and optionally, without generating) the heading information 134. The control unit 470 may send a control signal to the spatial audio renderer 150 to perform the spatial audio adjustment 152 using the head rotation data 124. Thus, the control unit 470 can cause the processor 106 to adjust processing of the sensor data 122 and the GNSS data 334 based on a source 164 of spatial audio associated with the audio playback.

FIG. 5 depicts an example of components 500 associated with determining relative coordinates and real-world coordinates that may be included in the processor 106 of the device 402 of FIG. 4. FIG. 5 also depicts a diagram 502 illustrating the user's head 110, the device 402 (“mobile device”), and the head-mounted device 404 (“HMD”) of FIG. 4. In the diagram 502, a real-world coordinate system 592 is represented by an X-Y coordinate axis, and the user's head 110 is facing the device 402 (e.g., a mobile phone) and oriented in the negative Y direction of the real-world coordinate system 592. A relative coordinate system 590 is represented by an X′-Y′ coordinate axis and is defined relative to a display screen of the device 402 such that the direction orthogonal to (e.g., perpendicular to) and toward the display screen is the positive X′ direction.

The components 500 include a first application 510, a second application 512, one or more application programming interfaces (API) 504, the spatial audio renderer 150, and a relative/absolute position calculator 506. The first application 510 corresponds to a source of first spatial audio associated with the relative coordinate system 590, such as a video application that provides spatial audio oriented relative to the display screen of the device 402. The second application 512 corresponds to a source of second spatial audio associated with the real-world coordinate system 592, such as a navigation application that provides audio cues as spatial audio from real-world source locations.

The components 500 are configured to perform a first rotation of first spatial audio 540 (e.g., audio associated with a video played at the device 402) based on the relative coordinate system 590 of the head-mounted device 404 relative to the device 402. The first application 510 provides the first spatial audio 540 to the spatial audio renderer 150 using a first application programming interface 514 of the API 504 (“spatialAudioRelativeCoordinates”) that corresponds to the relative coordinate system 590.

The components 500 are also configured to perform a second rotation of second spatial audio 542 (e.g., audio location/navigation cues) based on the real-world coordinate system 592. The second application 512 provides the second spatial audio 542 to the spatial audio renderer 150 using a second application programming interface 516 of the API 504 (“spatialAudioRealWorldCoordinates”) corresponding to the real-world coordinate system 592.

In a particular implementation, the first rotation of the first spatial audio 540 and the second rotation of the second spatial audio 542 are performed during concurrent playback of the first spatial audio 540 and the second spatial audio 542. To illustrate, the processor 106 determines the first rotation at least partially based on an orientation of the head-mounted device 404 relative to the device 402 and determines the second rotation at least partially based on an orientation of the head-mounted device 404 relative to a heading 526 associated with the device 402, as described further below.

The relative/absolute position calculator 506 processes the first IMU data 414, the second IMU data 424, the GNSS data 334, or combination thereof, to generate positioning data 530. In a particular implementation, the relative/absolute position calculator 506 can include, or be included in, the relative orientation engine 440 of FIG. 4. The relative/absolute position calculator 506 determines a heading 526 based on the GNSS data 334, such as the heading estimation 353 generated by the heading estimator 352. Because the heading 526 is determined based on the GNSS data 334, the heading 526 is in real-world coordinates. The GNSS coordinate information (e.g., latitude and longitude coordinates) are included in coordinates 528.

The relative/absolute position calculator 506 determines a device orientation with respect to heading 520 by correlating an accelerometer axis of the second IMU 420 (on the device 402) with the GNSS heading information. The relative/absolute position calculator 506 determines a headset orientation with respect to device 522 based on the first IMU data 414 received from the head-mounted device 404 (e.g., via wireless sync to the device 402) and the second IMU data 424 from the second IMU 420 at the device 402. The relative/absolute position calculator 506 also determines a headset orientation with respect to heading 524 based on (e.g., as the sum of) the device orientation with respect to heading 520 and the headset orientation with respect to device 522.

The positioning data 530 includes an orientation of the head-mounted device 404 in the real-world coordinate system 592 and in the relative coordinate system 590. For example, the headset orientation with respect to device 522 indicates the orientation of the user's head 110 in the relative coordinate system 590, and the headset orientation with respect to heading 524 indicates the orientation of the user's head 110 in the real-world coordinate system 592. These can be used to determine the first rotation of the first spatial audio 540 and the second rotation of the second spatial audio 542, respectively, at the spatial audio renderer 150.

After performing the first rotation of the first spatial audio 540 and the second rotation of the second spatial audio 542 at the spatial audio renderer 150, the processor 106 is configured to mix the rotated first spatial audio 540 and the rotated second spatial audio 542 (e.g., before, during, or after binauralization) and send the resulting combined output audio 162 as dynamic spatial audio to the head-mounted device 404 for playback.

Providing the ability to use relative or real-world reference frames enables different types of applications to provide appropriate spatial audio adjustments for different use cases. In an illustrative example, if a navigation application (e.g., the second application 512) indicates via the spatial AudioRealWorldCoordinates API that an audio cue is to be played out at +90 degrees with respect to the location of the user, the operating system of the device 402 translates the +90 degrees to the real-world coordinate system 592 (i.e., in the Y direction, behind the user), indicated as a real-world source position 582, instead of a relative source position 580 corresponding to +90 degrees in the relative coordinate system 590 (e.g., in the Y′ direction, at the user's right). If the user is sitting on a bus and is sitting perpendicular to the direction of travel of the bus (indicated by the heading 526), then without the translation to real-world coordinates the audio cue would play at the user's right earbud, which would indicate the direction of travel of the bus. However, with the coordinate translation, the audio cue plays behind the user (e.g., to indicate a right turn) so when the bus turns, the audio cue can correspond to how the user experiences the movement.

Continuing the above example, for a video application (e.g., the first application 510), the audio should be oriented in the relative coordinate system 590 with respect to the display screen on the device 402. Otherwise, the user would experience the sound for the video application (e.g., the first spatial audio 540) as continually changing orientation based on the motion of the bus even though the user is stationary with respect to the bus and the display screen.

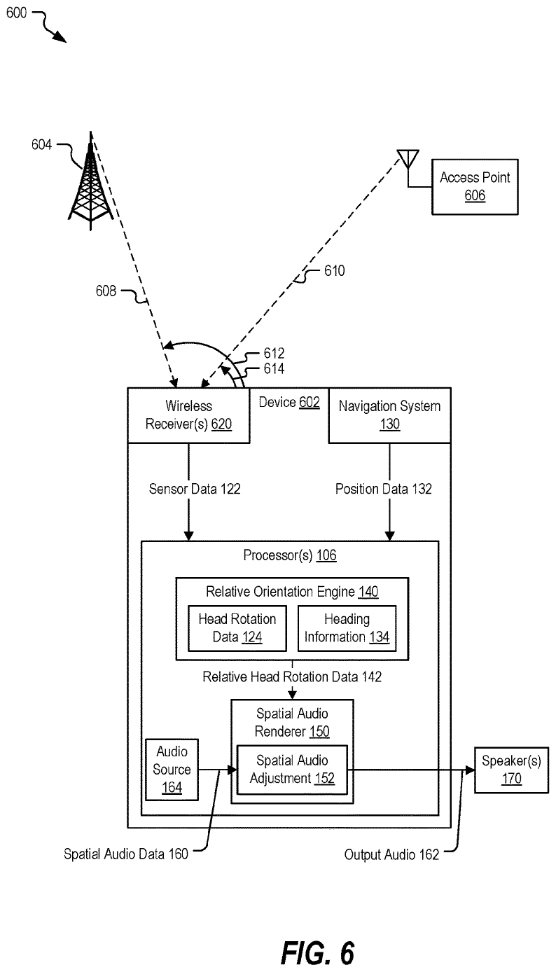

FIG. 6 depicts an example of a system 600 that includes a device 602 that is configured to use wireless signals from multiple wireless sources to generate the head rotation data 124. The device 602 includes the navigation system 130 and the processor 106 of FIG. 1, and one or more wireless receivers 620. According to an aspect, the device 602 corresponds to an implementation of the head-mounted device 302 in which the sensor data 122 indicative of the user's head movement is generated by the wireless receiver 620 instead of by the IMU 320.

The wireless receiver 620 is configured to generate the sensor data 122 corresponding to wireless signals 608, 610 received from one or more wireless network sources. As illustrated, the wireless receiver 620 receives first wireless signals 608 from a first wireless network source 604, such as a transmitter of an LTE network or 5G New Radio (NR) as illustrative, non-limiting examples (LTE is a trademark of European Telecommunications Standards Institute). The wireless receiver 620 also receives second wireless signals 610 from a second wireless network source 606, such as an access point of a WI-FI network.

In a particular example, the wireless receiver 620 is coupled to one or more antenna arrays of the device 602 and is configured to determine a first angle of arrival 612 of the first wireless signals 608 and to generate a second angle of arrival 614 of the second wireless signals 610. The first angle of arrival 612 indicates an orientation of the antenna array of the device 602 relative to the first wireless network source 604, and the second angle of arrival 614 indicates an orientation of the antenna array of the device 602 relative to the second wireless network source 606. The first angle of arrival 612 and the second angle of arrival 614 are included in the sensor data 122 that is generated by the wireless receiver 620 and sent to the processor 106.

According to an aspect, the one or more processors 106 are configured to generate the head rotation data 124 based on the angles of arrival 612, 614 of the wireless signals 608, 610. In an example, the relative orientation engine 140 is configured to detect changes in the first angle of arrival 612, the second angle of arrival 614, or both, that indicate a change of orientation of the device 602 relative to the respective wireless network sources 604, 606 as a result of user head movement, and the detected change of orientation corresponds to the head rotation data 124.

The relative orientation engine 140 generates the relative head rotation data 142 based on the head rotation data 124 and the heading information 134, and the spatial audio renderer 150 processes the spatial audio data 160 to generate the output audio 162 for playout to the speakers 170 in a similar manner as described with reference to the head-mounted device 302 of FIG. 3.

Thus, the device 602 enables accurate compensation of spatial audio based on a user's relative head rotation that is determined using the navigation system 130 and the wireless receiver 620. In some implementations, an IMU (not shown) at the device 602 can be deactivated for reduced power consumption or may be omitted from the device 602 for reduced cost. In some implementations in which the device 602 includes the IMU 320 of FIG. 3, the processor 106 may select between use of the angle of arrival data from the wireless receiver 620 or the IMU data 324 based on a quality of the angle of arrival data as compared to a quality of the IMU data 324. In some implementations in which the device 602 includes the IMU 320, the processor 106 may generate the head rotation data 124 based on a weighted sum of a head rotation determined based on the angle of arrival data with a head rotation determined based on the IMU data 324, and the weights may be based on the relative quality of the data from the respective sources.

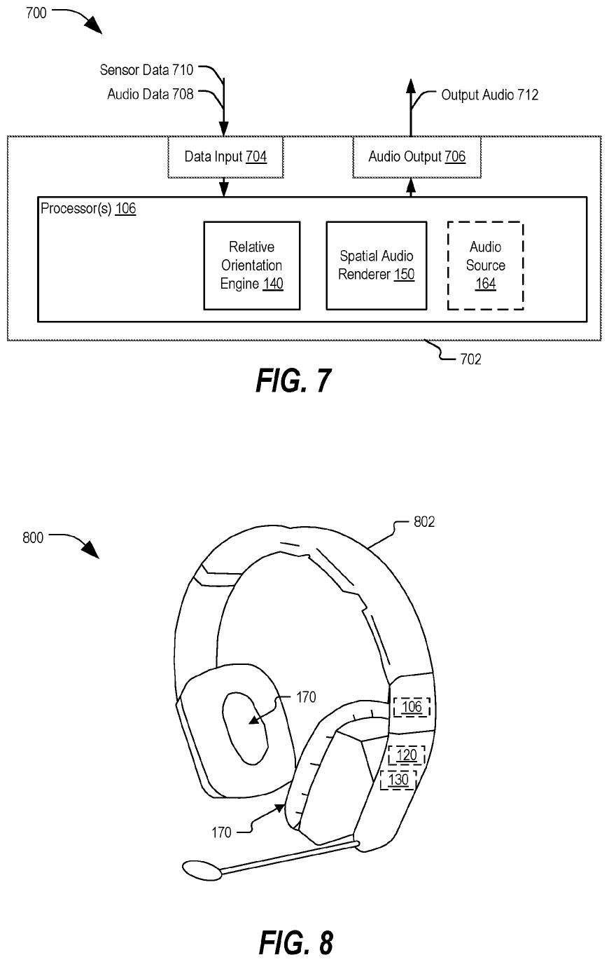

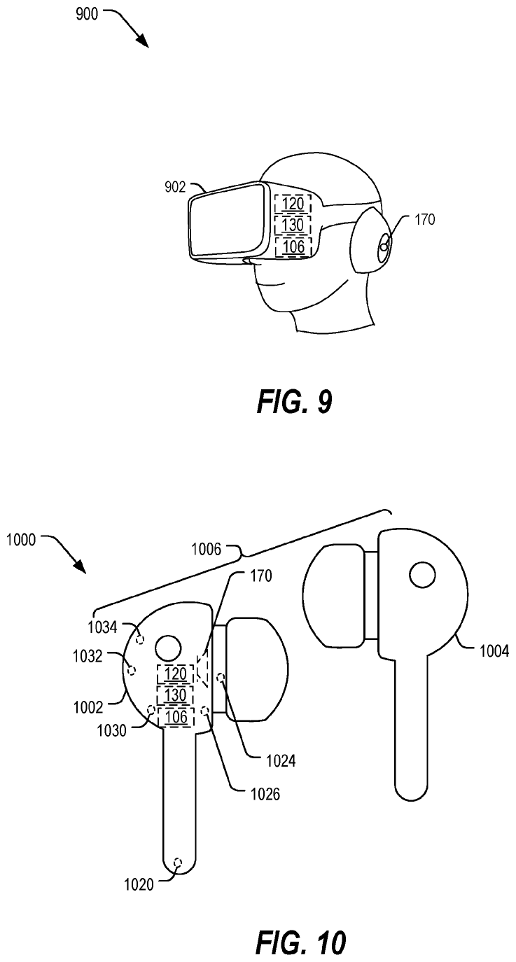

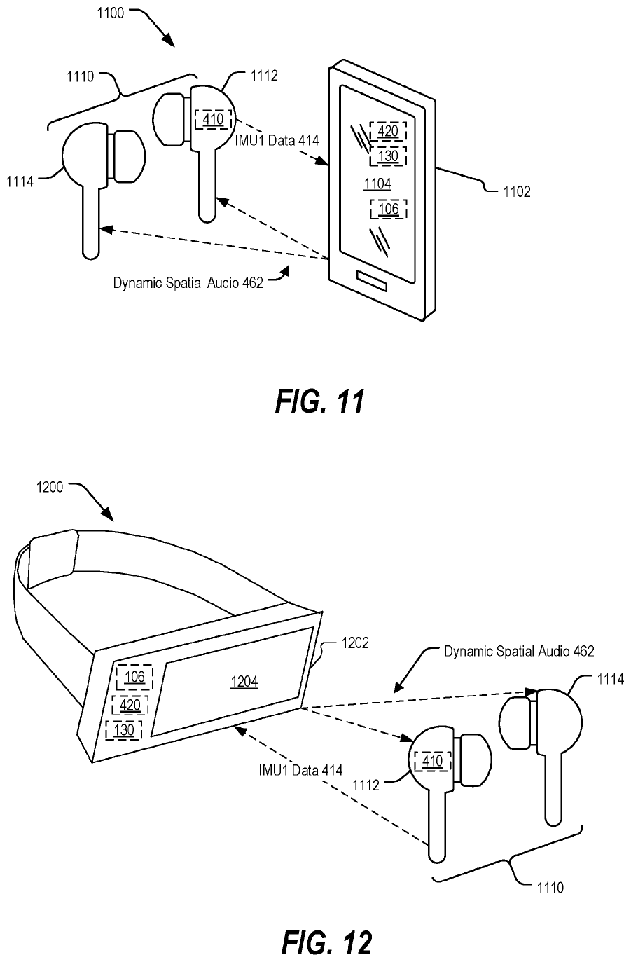

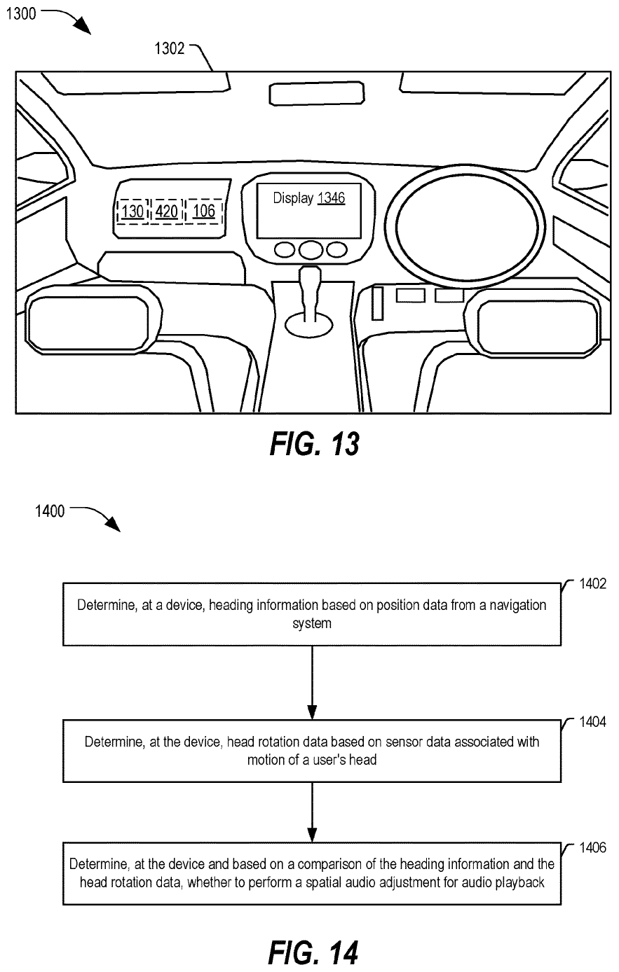

FIG. 7 depicts an implementation 700 of the device 102 as an integrated circuit 702 that includes the processor 106. The processor 106 includes the relative orientation engine 140 and the spatial audio renderer 150, and optionally includes the audio source 164. The integrated circuit 702 also includes a data input 704, such as one or more microphone inputs and/or bus interfaces, to enable audio data 708 and sensor data 710 to be received for processing. To illustrate, the audio data 708 can correspond to the spatial audio data 160 received from an external source, and the sensor data 710 can correspond to the sensor data 122, the position data 132, or both, as illustrative, non-limiting examples. The integrated circuit 702 also includes an audio output 706, such as a bus interface and/or analog output, to enable sending of an output audio signal 712, such as the output audio 162. The integrated circuit 702 enables the processor 106 to be integrated (e.g., included as a component) in a system that includes head motion sensors (e.g., an IMU) and a navigation system (e.g., a GNSS system), such as an audio headset as depicted in FIG. 8, an XR device as depicted in FIG. 9, a pair of earbuds as depicted in FIG. 10, a mobile phone or tablet computer device as depicted in FIG. 11, a wearable electronic device as depicted in FIG. 12, or a vehicle as depicted in FIG. 13.

FIG. 8 depicts an implementation 800 in which the device 102 includes a headset device 802. The headset device 802 includes the speakers 170 and may further include one or more microphones. The processor 106, the head motion sensors 120, and the navigation system 130 are integrated in the headset device 802 and illustrated using dashed lines to indicate internal components that are not generally visible to a user of the headset device 802. The headset device 802 is configured to perform spatial audio adjustment, of audio to be played out via the speakers 170, based on user heading and head rotation in a single-device implementation. To illustrate, in a particular example, the headset device 802 corresponds to the head-mounted device 302.

FIG. 9 depicts an implementation 900 in which the device 102 includes a portable electronic device that corresponds to an XR device, such as a virtual reality, mixed reality, or augmented reality headset 902. The head motion sensors 120, the navigation system 130, the processor 106, the speakers 170, or a combination thereof, are integrated into the headset 902. In a particular aspect, a visual interface device is positioned in front of the user's eyes to enable display of augmented reality, mixed reality, or virtual reality images or scenes to the user while the headset 902 is worn, and rotations of the user's head can result in corresponding adjustments to the spatial audio and the visual content prior to playout at the speakers 170 and the visual interface device, respectively. In a particular example, the spatial audio, the visual content, or both, are adjusted based on user heading and head rotation in a single-device implementation. To illustrate, in a particular example, the headset 902 corresponds to the head-mounted device 302.

FIG. 10 depicts an implementation 1000 in which the device 102 includes a portable electronic device that corresponds to a pair of earbuds 1006 that includes a first earbud 1002 and a second earbud 1004. Although earbuds are described, it should be understood that the present technology can be applied to other in-ear or over-ear playback devices.

The first earbud 1002 includes a first microphone 1020, such as a high signal-to-noise microphone positioned to capture the voice of a wearer of the first earbud 1002, an array of one or more other microphones configured to detect ambient sounds and spatially distributed to support beamforming, illustrated as microphones 1030, 1032, and 1034, an “inner” microphone 1024 proximate to the wearer's ear canal (e.g., to assist with active noise cancelling), and a self-speech microphone 1026, such as a bone conduction microphone configured to convert sound vibrations of the wearer's ear bone or skull into an audio signal.

The processor 106, the head motion sensors 120, and the navigation system 130 are integrated in the first earbud 1002. The processor 106 is configured to perform spatial audio adjustment, of audio to be played out via the speaker 170, based on user heading and head rotation in a single-device implementation. To illustrate, in a particular example, the first earbud 1002 and the second earbud 1004 jointly operate in a substantially similar manner as described for the head-mounted device 302.

In a particular implementation, audio signals generated by the microphones 1020 and 1030-1034 may be processed to generate spatial audio data corresponding to one or more sources of ambient sound. In some implementations, the spatial audio data from the ambient sources may be selectively adjusted to compensate for the user's head movements, such as to cause the spatial ambient sound to appear to the user to be head-locked audio that does not change position as the user's head changes orientations. In some implementations, the spatial ambient sound may be mixed with the output audio 162 corresponding to the spatial audio data 160 for playout to the user in an augmented reality-type implementation, as described further below.

The second earbud 1004 can be configured in a substantially similar manner as the first earbud 1002. In some implementations, an audio signal of the output audio 162 generated at the first earbud 1002 (e.g., one channel of the binaural output signal 362 of FIG. 3) is transmitted to the second earbud 1004 for playback, such as via wireless transmission between the earbuds 1002, 1004, or via wired transmission in implementations in which the earbuds 1002, 1004 are coupled via a transmission line. In other implementations, the second earbud 1004 also includes a processor 106 that receives the sensor data 122, the position data 132, or both, transmitted from the first earbud 1002 and performs spatial audio adjustment for playback at the speaker 170 of the second earbud 1004 in parallel with the spatial audio adjustment performed at the processor 106 of the first earbud 1002.

In some implementations, the earbuds 1002, 1004 are configured to automatically switch between various operating modes, such as a passthrough mode in which ambient sound is played via the speakers 170, a playback mode in which non-ambient sound (e.g., streaming audio corresponding to a phone conversation, media playback, video game, etc.) is played back through the speakers 170, and an audio zoom mode or beamforming mode in which one or more ambient sounds are emphasized and/or other ambient sounds are suppressed for playback at the speakers 170. In other implementations, the earbuds 1002, 1004 may support fewer modes or may support one or more other modes in place of, or in addition to, the described modes.

In an illustrative example, the earbuds 1002, 1004 can automatically transition from the playback mode to the passthrough mode in response to detecting the wearer's voice, and may automatically transition back to the playback mode after the wearer has ceased speaking. In some examples, the earbuds 1002, 1004 can operate in two or more of the modes concurrently, such as by performing audio zoom on a particular ambient sound (e.g., a dog barking) and playing out the audio zoomed sound superimposed on the sound being played out while the wearer is listening to music (e.g., head rotation adjusted spatial audio which can be reduced in volume while the audio zoomed sound is being played). In this example, the wearer can be alerted to the ambient sound associated with the audio event without halting playback of the music.

FIG. 11 depicts an implementation 1100 in which the device 102 includes a mobile device 1102, such as a phone or tablet computer device, as illustrative, non-limiting examples. The mobile device 1102 includes a display screen 1104 and is wirelessly coupled to a head-mounted device 1110, such as a pair of earbuds 1112, 1114 that include the first IMU 410. The processor 106, the navigation system 130, and the second IMU 420 are integrated in the mobile device 1102. In a particular example, the mobile device 1102 is configured to perform spatial audio adjustment based on the first IMU data 414 received from the head-mounted device 1110, based on second IMU data 424 from the second IMU 420, based on position data received from the navigation system 130, or a combination thereof. To illustrate, in a particular example, the earbuds 1112, 1114 correspond to the head-mounted device 404 of FIG. 4 and the mobile device 1102 corresponds to the device 402, which sends the dynamic spatial audio 462 to the earbuds 1112, 1114 for playout.

In a particular example, the processor 106 is configured to selectively update an operating mode associated with the spatial audio adjustment responsive to user instructions (e.g., received via a graphical user interface at the display screen 1104). For example, the mobile device 1102 may present a graphical user interface via the display screen 1104 that enables the user to select whether dynamic spatial audio is enabled or disabled at the spatial audio renderer 150. As another example, the graphical user interface may enable the user to select whether the spatial audio adjustment is determined based on the first IMU data 414 from the first IMU 410, the second IMU data 424 from the second IMU 420, the position data 132 from the navigation system 130 (e.g., the GNSS data 334 from the GNSS system 330), or combinations thereof.

FIG. 12 depicts an implementation 1200 in which the device 102 includes a wearable electronic device 1202, illustrated as a “smart watch.” The wearable electronic device 1202 includes a display screen 1204 and is wirelessly coupled to the head-mounted device 1110 (e.g., the pair of earbuds 1112, 1114 having the first IMU 410). The processor 106, the navigation system 130, and the second IMU 420 are integrated in the wearable electronic device 1202. In a particular example, the wearable electronic device 1202 is configured to perform spatial audio adjustment based on the first IMU data 414 received from the head-mounted device 1110, based on second IMU data 424 from the second IMU 420, based on position data received from the navigation system 130, or a combination thereof. To illustrate, in a particular example, the earbuds 1112, 1114 correspond to the head-mounted device 404 of FIG. 4 and the wearable electronic device 1202 corresponds to the device 402, which sends the dynamic spatial audio 462 to the earbuds 1112, 1114 for playout. In a particular example, the processor 106 is configured to, responsive to user instructions (e.g., received via a graphical user interface at the display screen 1204), selectively update an operating mode associated with the spatial audio adjustment in a similar manner as described for the mobile device 1102 of FIG. 11.

FIG. 13 depicts an implementation 1300 in which the device 102 corresponds to, or is integrated within, a vehicle 1302, illustrated as a car. The vehicle 1302 includes the processor 106, the navigation system 130, and the second IMU 420. For example, the navigation system 130 and the second IMU 420 may correspond to one or more acceleration sensors, gyroscopes, satellite positioning system receivers, sensors, and/or other components included in a vehicular navigation system of the vehicle 1302, such as to provide navigation assistance to a driver via a display 1346.

In a particular implementation, the processor 106 is configured to be wirelessly coupled to head-mounted devices (not shown) of one or more occupants of the vehicle 1302. For example, each passenger in the vehicle 1302 may wear a headset that receives streaming audio from an entertainment system of the vehicle 1302. Each passenger's headset may include one or more head motion sensors that transmit sensor data to the processor 106, such as the first IMU data 414 from the first IMU 410 of FIG. 4. The processor 106 may generate an individual stream of spatial audio data, such as the dynamic spatial audio 462, for each passenger to compensate for that passenger's individual head movement relative to the heading of the vehicle 1302. In a particular implementation, the vehicle 1302 corresponds to the device 402 of FIG. 4, and each passenger's headset corresponds to an instance of the head-mounted device 404. In a particular example, the vehicle 1302 is configured to perform spatial audio adjustments based on the first IMU data 414 received from each passenger's headset, based on second IMU data 424 from the second IMU 420, based on position data received from the navigation system 130, or a combination thereof, and sends the resulting dynamic spatial audio 462 for each passenger to that passenger's headset for playout.

Referring to FIG. 14, a particular implementation of a method 1400 of spatial audio adjustment based on user heading and head rotation is shown. In a particular aspect, one or more operations of the method 1400 are performed by at least one of the processor 106, the relative orientation engine 140, or the spatial audio renderer 150, the relative orientation engine 340 of FIG. 3, the relative orientation engine 440 or the control unit 470 of FIG. 4, the relative/absolute position calculator 506 of FIG. 5, or a combination thereof.

The method 1400 includes, at block 1402, determining, at a device, heading information based on position data from a navigation system. For example, the heading information 134 is determined at the device 102 based on the position data 132 from the navigation system 130. In some implementations, the navigation system corresponds to a satellite-based navigation system, such as the GNSS system 330.

The method 1400 includes, at block 1404, determining, at the device, head rotation data based on sensor data associated with motion of a user's head. For example, the head rotation data 124 is determined at the device 102 based on the sensor data 122 from the head motion sensors 120. In some implementations, the sensor data is received from an inertial measurement unit of a head-mounted device, such as the IMU 320 or the first IMU 410.

The method 1400 includes, at block 1406, determining, at the device and based on a comparison of the heading information and the head rotation data, whether to perform a spatial audio adjustment for audio playback. For example, the relative orientation engine 140 compares the heading information 134 to the head rotation data 124 and determines, based on the comparison, whether to perform the spatial audio adjustment 152 for audio playback. Performing the comparison can include determining a change in relative orientation of the user's head 110 as compared to the user's body 112. To illustrate, the relative orientation engine 140 can distinguish between rotation of the user's head 110 relative to the user's body 112, and rotation of the user's head 110 and body 112 together, based on whether rotation of the user's head 110 indicated by the head rotation data 124 matches a detected change in the heading 116 indicated by the heading information 134.

Optionally, in some implementations the method 1400 includes performing the spatial audio adjustment in response to detecting the rotation of the user's head relative to the user's body, or refraining from performing the spatial audio adjustment in response to detecting the rotation of the user's head and body together.

Optionally, in some implementations, the device corresponds to a head-mounted device of a hearable system (e.g., a pair of electronic earphones or other in-ear devices), and includes an inertial measurement unit and a navigation system receiver, such as the IMU 320 and the GNSS system 330, respectively, of the head-mounted device 302. The sensor data is received from the inertial measurement unit, and the position data is received from the navigation system receiver. In such implementations, the method 1400 may include processing the sensor data using an attitude filter to generate the head rotation data, such as the processing of the IMU data 324 performed by the attitude filter 342, to generate the head rotation data 124 indicating a head orientation change. The method 1400 may include processing the position data to determine a heading estimation, such as the heading estimation 353 generated by the heading estimator 352, and comparing the heading estimation to a reference heading to generate the heading information, such as the heading information 134 generated by the change calculator 356 based on the heading estimation 353 and the reference heading 355. The method 1400 may also include subtracting the heading information from the head rotation data to determine an amount of rotation of the user's head relative to the user's body, such as described with reference to the operation 360.

Optionally, in some implementations, the device is wirelessly coupled to a head-mounted device of a hearable system, such as the device 402 wirelessly coupled to the head-mounted device 404. In such implementations the method 1400 may include receiving first IMU data from a first IMU of the head-mounted device, such as the first IMU data 414 from the first IMU 410 of the head-mounted device 404. The first IMU data may be included in the sensor data and may indicate motion of the head-mounted device. The method 1400 may also include receiving the position data from a navigation system receiver of the device, such as the GNSS data 334 from the navigation receiver 332 of FIG. 4. The method 1400 may further include determining a relative orientation of the head-mounted device, in relation to an orientation of the device, at least partially based on the first IMU data and the position data. For example, the relative orientation engine 440 determines the relative head rotation data 142 at least partially based on the first IMU data 414 and the GNSS data 334.

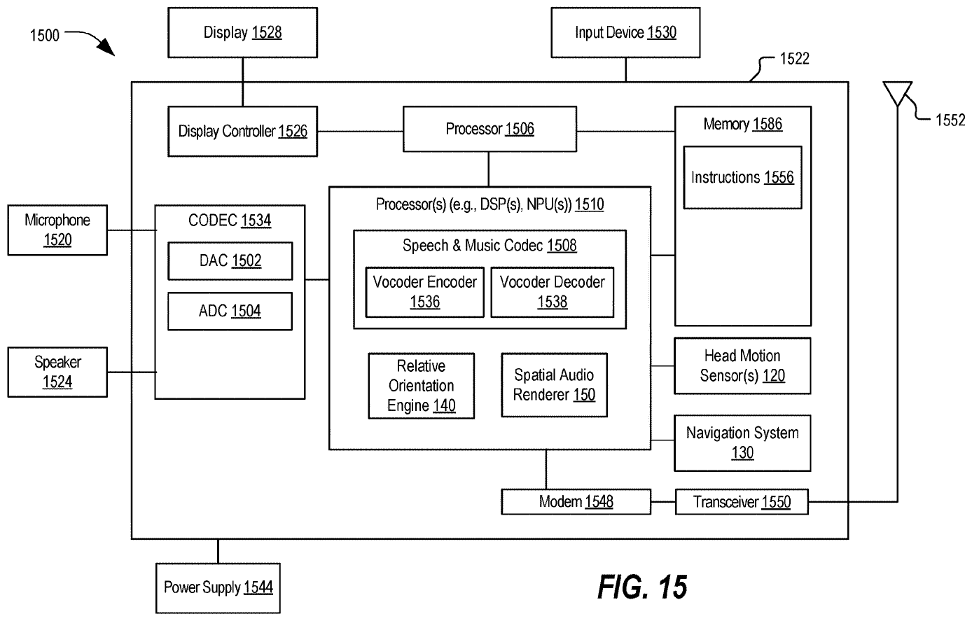

The method 1400 of FIG. 14 may be implemented by a field-programmable gate array (FPGA) device, an application-specific integrated circuit (ASIC), a processing unit such as a central processing unit (CPU), a DSP, a controller, another hardware device, firmware device, or any combination thereof. As an example, the method 1400 of FIG. 14 may be performed by a processor that executes instructions, such as described with reference to FIG. 15.

Referring to FIG. 15, a block diagram of a particular illustrative implementation of a device is depicted and generally designated 1500. In various implementations, the device 1500 may have more or fewer components than illustrated in FIG. 15. In an illustrative implementation, the device 1500 may correspond to the device 102. In an illustrative implementation, the device 1500 may perform one or more operations described with reference to FIGS. 1-14.

In a particular implementation, the device 1500 includes a processor 1506 (e.g., a CPU). The device 1500 may include one or more additional processors 1510 (e.g., one or more DSPs, one or more neural processing units (NPUs), or a combination thereof). In a particular aspect, the processor 106 of FIG. 1 is included in or corresponds to the processors 1510, the processor 1506, or a combination thereof. The processors 1510 may include a speech and music coder-decoder (CODEC) 1508 that includes a voice coder (“vocoder”) encoder 1536, a vocoder decoder 1538, or a combination thereof. In some implementations, the processors 1510 include the relative orientation engine 140 and the spatial audio renderer 150. The device 1500 may include the head motion sensors 120 and the navigation system 130 coupled to the processors 1510.

The device 1500 may include a memory 1586 and a CODEC 1534. The memory 1586 may include instructions 1556 that are executable by the one or more additional processors 1510 (or the processor 1506) to implement the functionality described with reference to the processor 106. The device 1500 may include a modem 1548 coupled, via a transceiver 1550, to an antenna 1552.

The device 1500 may include a display 1528 coupled to a display controller 1526. One or more speakers 1524 and one or more microphones 1520 may be coupled to the CODEC 1534. In a particular aspect, the one or more speakers 1524 include the speakers 170. The CODEC 1534 may include a digital-to-analog converter (DAC) 1502, an analog-to-digital converter (ADC) 1504, or both. In a particular implementation, the CODEC 1534 may receive analog signals from the microphone 1520, convert the analog signals to digital signals using the analog-to-digital converter 1504, and provide the digital signals to the speech and music codec 1508. In a particular implementation, the speech and music codec 1508 may provide digital signals to the CODEC 1534. The CODEC 1534 may convert the digital signals to analog signals using the digital-to-analog converter 1502 and may provide the analog signals to the speaker 1524.

In a particular implementation, the device 1500 may be included in a system-in-package or system-on-chip device 1522. In a particular implementation, the head motion sensors 120, the navigation system 130, the memory 1586, the processor 1506, the processors 1510, the display controller 1526, the CODEC 1534, the transceiver 1550, and the modem 1548 are included in the system-in-package or system-on-chip device 1522. In a particular implementation, an input device 1530 and a power supply 1544 are coupled to the system-in-package or the system-on-chip device 1522. Moreover, in a particular implementation, as illustrated in FIG. 15, the display 1528, the input device 1530, the speaker 1524, the microphone 1520, the antenna 1552, and the power supply 1544 are external to the system-in-package or the system-on-chip device 1522. In a particular implementation, each of the display 1528, the input device 1530, the speaker 1524, the microphone 1520, the antenna 1552, and the power supply 1544 may be coupled to a component of the system-in-package or the system-on-chip device 1522, such as an interface or a controller.

The device 1500 may include a mobile communication device, a smart phone, a cellular phone, a laptop computer, a computer, a tablet, a personal digital assistant, a display device, a gaming console, a music player, a radio, a digital video player, a digital video disc (DVD) player, a tuner, a camera, a navigation device, a vehicle, a headset, an augmented reality headset, a mixed reality headset, a virtual reality headset, an aerial vehicle, a voice-activated device, a portable electronic device, a car, a computing device, a communication device, an internet-of-things (IoT) device, an XR device, a mobile device, or any combination thereof.

In conjunction with the described implementations, an apparatus includes means for determining heading information based on position data from a navigation system. For example, the means for determining heading information based on position data from a navigation system can correspond to the device 102, the processor 106, or the relative orientation engine 140, the head-mounted device 302, the relative orientation engine 340, the heading estimator 352, the memory 354, the change calculator 356, the device 402, the relative orientation engine 440, the relative/absolute position calculator 506, one or more other circuits or components configured to determine heading information based on position data from a navigation system, or any combination thereof.

The apparatus includes means for determining head rotation data based on sensor data associated with motion of a user's head. For example, the means for determining head rotation data based on sensor data associated with motion of a user's head can correspond to the device 102, the processor 106, or the relative orientation engine 140, the head-mounted device 302, the relative orientation engine 340, the attitude filter 342, the device 402, the relative orientation engine 440, the attitude filter 442, the relative/absolute position calculator 506, one or more other circuits or components configured to determine head rotation data based on sensor data associated with motion of a user's head, or any combination thereof.

The apparatus includes means for determining, based on a comparison of the heading information and the head rotation data, whether to perform a spatial audio adjustment for audio playback. For example, the means determining, based on a comparison of the heading information and the head rotation data, whether to perform a spatial audio adjustment for audio playback can correspond to the device 102, the processor 106, or the relative orientation engine 140, the spatial audio renderer 150, the head-mounted device 302, the relative orientation engine 340, the device 402, the relative orientation engine 440, the control unit 470, the relative/absolute position calculator 506, one or more other circuits or components configured to determine, based on a comparison of the heading information and the head rotation data, whether to perform a spatial audio adjustment for audio playback, or any combination thereof.

In some implementations, a non-transitory computer-readable medium (e.g., a computer-readable storage device, such as the memory 1586) includes instructions (e.g., the instructions 1556) that, when executed by one or more processors (e.g., the processor 106, the one or more processors 1510, or the processor 1506), cause the one or more processors to determine heading information (e.g., the heading information 134) based on position data (e.g., the position data 132) from a navigation system (e.g., the navigation system 130), determine head rotation data (e.g., the head rotation data 124) based on sensor data (e.g., the sensor data 122) associated with motion of a user's head, and determine, based on a comparison of the heading information and the head rotation data, whether to perform a spatial audio adjustment (e.g., the spatial audio adjustment 152) for audio playback.

Particular aspects of the disclosure are described below in sets of interrelated Examples:

According to Example 1, a device includes one or more processors configured to determine heading information based on position data from a navigation system; determine head rotation data based on sensor data associated with motion of a user's head; and determine, based on a comparison of the heading information and the head rotation data, whether to perform a spatial audio adjustment for audio playback.

Example 2 includes the device of Example 1, further comprising an inertial measurement unit, and wherein the sensor data is received from the inertial measurement unit.

Example 3 includes the device of Example 1 or Example 2, wherein the navigation system corresponds to a satellite-based navigation system.

Example 4 includes the device of any of Examples 1 to 3, wherein the one or more processors are implemented in a hearable system and configured to distinguish between rotation of the user's head relative to the user's body, and rotation of the user's head and body together; perform the spatial audio adjustment in response to detecting the rotation of the user's head relative to the user's body; and refrain from performing the spatial audio adjustment in response to detecting the rotation of the user's head and body together.

Example 5 includes the device of any of Examples 1 to 4, wherein the comparison includes determining a change in relative orientation of the user's head as compared to the user's body.

Example 6 includes the device of any of Examples 1 to 5, wherein the one or more processors are further configured to perform the spatial audio adjustment at a spatial audio renderer to generate a binaural output signal.

Example 7 includes the device of any of Examples 1 to 6, wherein, when the user's head rotates while the user's body is stationary, the head rotation data indicates that the user's head has rotated and the heading information indicates no change of heading, and the one or more processors perform the spatial audio adjustment.

Example 8 includes the device of any of Examples 1 to 7, wherein, when the user's head rotates while the user walks in a straight line, the head rotation data indicates that the user's head has rotated and the heading information indicates no change of heading, and the one or more processors perform the spatial audio adjustment.

Example 9 includes the device of any of Examples 1 to 8, wherein, when the user walks around a corner without the user's head rotating relative to the user's body, the head rotation data indicates that the user's head has rotated and the heading information indicates a change of heading matching the rotation of the user's head, and the one or more processors do not perform the spatial audio adjustment.

Example 10 includes the device of any of Examples 1 to 9, wherein the one or more processors are further configured to process the sensor data using an attitude filter to generate the head rotation data, the head rotation data indicating a head orientation change; process the position data to determine a heading estimation; compare the heading estimation to a reference heading to generate the heading information, the heading information indicating a heading change; and subtract the heading information from the head rotation data to determine an amount of rotation of the user's head relative to the user's body.

Example 11 includes the device of any of Examples 1 to 10 and further includes a control unit configured to cause the one or more processors to adjust processing of the sensor data and the position data based on one or more detected conditions.

Example 12 includes the device of any of Examples 1 to 11, wherein the one or more processors, an inertial measurement unit configured to generate the sensor data, and a navigation system receiver configured to generate the position data are integrated in a head-mounted device.

Example 13 includes the device of any of Examples 1 to 10 and further includes a receiver configured to receive first inertial measurement unit (IMU) data from a first IMU of a head-mounted device, the first IMU data included in the sensor data and indicating motion of the head-mounted device; a second IMU configured to generate second IMU data, the second IMU data included in the sensor data and indicating motion of the device; and a navigation system receiver configured to generate the position data indicating a position of the device, wherein the one or more processors are configured to determine a relative orientation of the head-mounted device, in relation to an orientation of the device, based on the first IMU data, the second IMU data, and the position data.

Example 14 includes the device of Example 13 and further includes a control unit configured to cause the one or more processors to adjust processing of the sensor data and the position data based on one or more detected conditions.

Example 15 includes the device of Example 14, wherein the control unit is configured to cause the one or more processors to determine the relative orientation of the head-mounted device based on the first IMU data and the position data when the device is detected to be in a pocket.

Example 16 includes the device of Example 14 or Example 15, wherein the control unit is configured to cause the one or more processors to determine the relative orientation of the head-mounted device based on the first IMU data and the position data when the second IMU data is detected to be incoherent with respect to the first IMU data.

Example 17 includes the device of any of Examples 14 to 16, wherein the control unit is configured to cause the one or more processors to determine the relative orientation of the head-mounted device based on the first IMU data and the second IMU data upon detection that the position data is unavailable.

Example 18 includes the device of any of Examples 14 to 17, wherein the control unit is configured to cause the one or more processors to adjust processing of the sensor data and the position data based on a source of spatial audio associated with the audio playback.

Example 19 includes the device of any of Examples 13 to 18, wherein the one or more processors are configured to perform a first rotation of first spatial audio based on a relative coordinate system of the head-mounted device relative to the device and a second rotation of second spatial audio based on a real-world coordinate system during concurrent playback of the first spatial audio and the second spatial audio.

Example 20 includes the device of Example 19, wherein the one or more processors are configured to include a first application that provides the first spatial audio using a first application programming interface corresponding to the relative coordinate system and a second application that provides the second spatial audio using a second application programming interface corresponding to the real-world coordinate system.

Example 21 includes the device of Example 19 or Example 20, wherein the one or more processors are configured to determine the second rotation at least partially based on an orientation of the head-mounted device relative to a heading associated with the device.

Example 22 includes the device of any of Examples 13 to 21, wherein the one or more processors are configured to send dynamic spatial audio to the head-mounted device for playback.

Example 23 includes the device of any of Examples 1 to 22, wherein the sensor data corresponds to wireless signals, received from one or more wireless network sources, and wherein the one or more processors are configured to generate the head rotation data based on angles of arrival of the wireless signals.

According to Example 24, a method includes determining, at a device, heading information based on position data from a navigation system; determining, at the device, head rotation data based on sensor data associated with motion of a user's head; and determining, at the device and based on a comparison of the heading information and the head rotation data, whether to perform a spatial audio adjustment for audio playback.

Example 25 includes the method of Example 24, wherein the sensor data is received from an inertial measurement unit of the device, and wherein the navigation system corresponds to a satellite-based navigation system.

Example 26 includes the method of Example 24 or Example 25, wherein determining whether to perform the spatial audio adjustment includes distinguishing between rotation of the user's head relative to the user's body, and rotation of the user's head and body together, and wherein the method further comprises: performing the spatial audio adjustment in response to detecting the rotation of the user's head relative to the user's body, or refraining from performing the spatial audio adjustment in response to detecting the rotation of the user's head and body together.

Example 27 includes the method of any of Examples 24 to 26, wherein the device corresponds to a head-mounted device of a hearable system, the device including an inertial measurement unit and a navigation system receiver, wherein the sensor data is received from the inertial measurement unit, and wherein the position data is received from the navigation system receiver.

Example 28 includes the method of Example 27 and further includes processing the sensor data using an attitude filter to generate the head rotation data, the head rotation data indicating a head orientation change; processing the position data to determine a heading estimation; comparing the heading estimation to a reference heading to generate the heading information, the heading information indicating a heading change; and subtracting the heading information from the head rotation data to determine an amount of rotation of the user's head relative to the user's body.

Example 29 includes the method of any of Examples 24 to 26, wherein the device is wirelessly coupled to a head-mounted device of a hearable system, and the method further includes receiving first inertial measurement unit (IMU) data from a first IMU of the head-mounted device, the first IMU data included in the sensor data and indicating motion of the head-mounted device; receiving the position data from a navigation system receiver of the device; and determining a relative orientation of the head-mounted device, in relation to an orientation of the device, at least partially based on the first IMU data and the position data.

According to Example 30, a device includes: a memory configured to store instructions; and a processor configured to execute the instructions to perform the method of any of Examples 24 to 29.

According to Example 31, a non-transitory computer-readable medium stores instructions that, when executed by a processor, cause the processor to perform the method of any of Examples 24 to 29.

According to Example 32, an apparatus includes means for carrying out the method of any of Examples 24 to 29.

According to Example 33, a non-transitory computer-readable medium stores instructions that, when executed by one or more processors, cause the one or more processors to determine heading information based on position data from a navigation system; determine head rotation data based on sensor data associated with motion of a user's head; and determine, based on a comparison of the heading information and the head rotation data, whether to perform a spatial audio adjustment for audio playback.

According to Example 34, an apparatus includes means for determining heading information based on position data from a navigation system; means for determining head rotation data based on sensor data associated with motion of a user's head; and means for determining, based on a comparison of the heading information and the head rotation data, whether to perform a spatial audio adjustment for audio playback.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

1. A device comprising:
one or more processors configured to:
determine heading information based on position data from a navigation system;
determine head rotation data based on sensor data associated with motion of a user's head; and
determine, based on a comparison of the heading information and the head rotation data, whether to perform a spatial audio adjustment for audio playback.

2. The device of claim 1, further comprising an inertial measurement unit, and wherein the sensor data is received from the inertial measurement unit.

3. The device of claim 2, wherein the navigation system corresponds to a satellite-based navigation system.

4. The device of claim 1, wherein the one or more processors are implemented in a hearable system and configured to:
distinguish between rotation of the user's head relative to the user's body, and rotation of the user's head and body together;
perform the spatial audio adjustment in response to detecting the rotation of the user's head relative to the user's body; and
refrain from performing the spatial audio adjustment in response to detecting the rotation of the user's head and body together.

5. The device of claim 1, wherein the comparison includes determining a change in relative orientation of the user's head as compared to the user's body.

6. The device of claim 1, wherein the one or more processors, an inertial measurement unit configured to generate the sensor data, and a navigation system receiver configured to generate the position data are integrated in a head-mounted device.

7. The device of claim 6, wherein the one or more processors are further configured to:
process the sensor data using an attitude filter to generate the head rotation data, the head rotation data indicating a head orientation change;
process the position data to determine a heading estimation;
compare the heading estimation to a reference heading to generate the heading information, the heading information indicating a heading change; and
subtract the heading information from the head rotation data to determine an amount of rotation of the user's head relative to the user's body.

8. The device of claim 1, wherein the one or more processors are further configured to perform the spatial audio adjustment at a spatial audio renderer to generate a binaural output signal.

9. The device of claim 1, wherein, when the user's head rotates while the user's body is stationary, the head rotation data indicates that the user's head has rotated and the heading information indicates no change of heading, and the one or more processors perform the spatial audio adjustment.

10. The device of claim 1, wherein, when the user's head rotates while the user walks in a straight line, the head rotation data indicates that the user's head has rotated and the heading information indicates no change of heading, and the one or more processors perform the spatial audio adjustment.

11. The device of claim 1, wherein, when the user walks around a corner without the user's head rotating relative to the user's body, the head rotation data indicates that the user's head has rotated and the heading information indicates a change of heading matching the rotation of the user's head, and the one or more processors do not perform the spatial audio adjustment.

12. The device of claim 1, further comprising:
a receiver configured to receive first inertial measurement unit (IMU) data from a first IMU of a head-mounted device, the first IMU data included in the sensor data and indicating motion of the head-mounted device;
a second IMU configured to generate second IMU data, the second IMU data included in the sensor data and indicating motion of the device; and
a navigation system receiver configured to generate the position data indicating a position of the device,
wherein the one or more processors are configured to determine a relative orientation of the head-mounted device, in relation to an orientation of the device, based on the first IMU data, the second IMU data, and the position data.

13. The device of claim 12, further comprising a control unit configured to cause the one or more processors to adjust processing of the sensor data and the position data based on one or more detected conditions.

14. The device of claim 13, wherein the control unit is configured to cause the one or more processors to determine the relative orientation of the head-mounted device based on the first IMU data and the position data when the device is detected to be in a pocket.

15. The device of claim 13, wherein the control unit is configured to cause the one or more processors to determine the relative orientation of the head-mounted device based on the first IMU data and the position data when the second IMU data is detected to be incoherent with respect to the first IMU data.

16. The device of claim 13, wherein the control unit is configured to cause the one or more processors to determine the relative orientation of the head-mounted device based on the first IMU data and the second IMU data upon detection that the position data is unavailable.

17. The device of claim 13, wherein the control unit is configured to cause the one or more processors to adjust processing of the sensor data and the position data based on a source of spatial audio associated with the audio playback.

18. The device of claim 12, wherein the one or processors are configured to perform a first rotation of first spatial audio based on a relative coordinate system of the head-mounted device relative to the device and a second rotation of second spatial audio based on a real-world coordinate system during concurrent playback of the first spatial audio and the second spatial audio.

19. The device of claim 18, wherein the one or more processors are configured to include a first application that provides the first spatial audio using a first application programming interface corresponding to the relative coordinate system and a second application that provides the second spatial audio using a second application programming interface corresponding to the real-world coordinate system.

20. The device of claim 18, wherein the one or more processors are configured to determine the second rotation at least partially based on an orientation of the head-mounted device relative to a heading associated with the device.

21-30. (canceled)
